(19) United States
(12) Patent Application Publication
(10) Pub. No.: US 2024/0003384 A1
(43) Pub. Date: Jan. 4, 2024

(54) SUPPORT ASSEMBLY FOR FOOD APPLICATIONS

(71) Applicant: AKTIEBOLAGET SKF, GÖTENBORG (SE)

(72) Inventors: Pasquale Frezza, Aversa (CE) (IT); Andrea A. Bertolini, Carrara (IT); Renato Berti, Massa (MS) (IT)

(21) Appl. No.: 18/210,104

(22) Filed: Jun. 15, 2023

(30) Foreign Application Priority Data
Jun. 30, 2022 (IT) 102022000013810

(51) Int. Cl. F16C 33/58; F16C 19/06; F16C 35/04

(52) U.S. Cl. CPC F16C 33/583; F16C 19/06; F16C 35/042

(57) ABSTRACT

A support assembly for a shaft includes a bearing unit adapted to receive the shaft and a cover for sealing the bearing unit. The bearing unit includes a radially outer ring and a radially inner ring, and the cover includes a bottom wall, a side wall integrally connected to the bottom wall, and a engaging portion extending from a distal end of the side wall. The engaging portion forms a dynamic seal with an axially outer annular surface of the radially outer ring. The cover is secured to the radially inner ring of the support assembly.

### CROSS-REFERENCE TO RELATED APPLICATIONS

This application is based on and claims priority to Italian Patent Application No. 102022000013810 filed on Jun. 30, 2022, under 35 U.S.C. § 119, the disclosure of which is incorporated herein by reference in its entirety.

### FIELD

The present disclosure relates to a support assembly for bearing units. In particular, the present disclosure relates to a support assembly in which the support assembly is secured to a machine frame and intended to support movable shafts by means of a bearing unit.

### BACKGROUND

A focus of the food and beverage (F&B) industry is to develop new machines and machine designs aimed at improving the safety and quality of food and beverages.

Machines used in the food and beverage industry have many moving parts supported by rotating or sliding shafts, for example, conveyor belts, pasta makers, or machines for washing fresh produce.

These machines are cleaned, often with water to which detergents and/or disinfectants are added, in order to control the growth of bacteria that could contaminate the food or beverages. Contaminants, such as dirt and debris, and water can reside in crevices or other areas in the machines, becoming stagnant and encouraging bacterial growth.

### BRIEF DESCRIPTION OF THE DRAWINGS

The disclosure will now be described with reference to the attached drawings, which illustrate non-limiting exemplary embodiments of the disclosure, in which:

FIG. 1 shows a cross section of a support assembly according to the prior art;

FIG. 2 shows a cross section of a support assembly according to exemplary embodiments of the present disclosure;

FIG. 3 shows a detail view of FIG. 2;

FIG. 4 shows a detail view of a cover of the support assembly of FIG. 2 according to exemplary embodiments; and

FIG. 5 shows a radially inner ring of the support assembly of FIG. 2 according to exemplary embodiments.

### DETAILED DESCRIPTION

Support assemblies for movable shafts, which may be end supports receiving an end of the shaft, or through supports, may be particularly susceptible to bacterial growth from stagnant dirt and water trapped inside the assemblies. Such support assemblies generally include a casing having a base or flange for attachment to the machine, a bearing unit housed inside the casing and coupled to the movable shaft of the support assembly, and a cover force-fitted onto the casing.

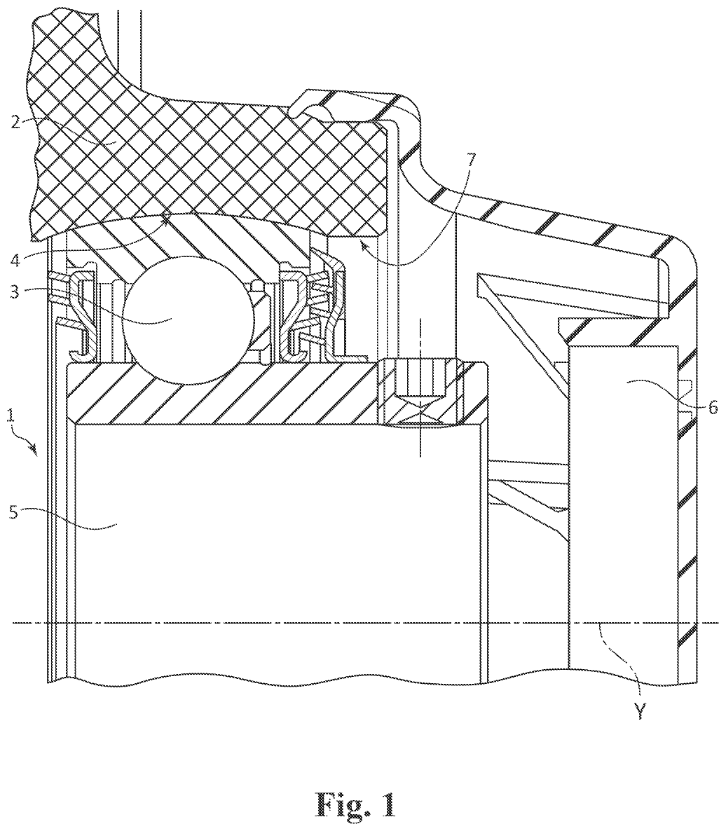

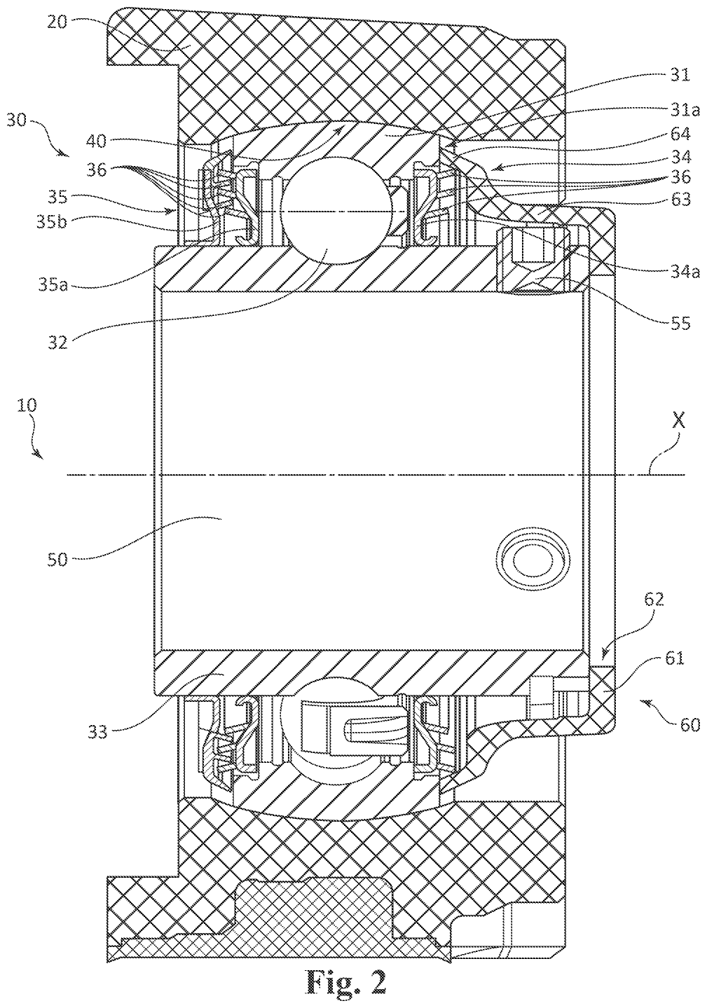

FIG. 1 shows an embodiment of a known support assembly 1. Support assembly 1 may include a bearing unit 3, for example a roller bearing adapted to receive a movable shaft 5, and a casing 2 having a through seat 4 that receives bearing unit 3. Casing 2 has a generally annular shape. Through seat 4 may include an axis of symmetry Y that coincides with an axis of symmetry of casing 2. In any case, support assembly 1 includes a cover 6 for sealing an inlet 7 of through seat 4 of casing 2 in a fluid-tight manner.

Thus, these known support assemblies have a cover mounted on the casing of the support assembly, creating a static seal between the cover and the casing. A static seal, however, has its drawbacks, as it does not guarantee a compact solution and the possibility of ascertaining the progress of the work during use. An additional drawback in known support assemblies is that the cover is generally closed at the bottom, making it impossible to pass the shaft of the support assembly through the cover itself. Lastly, a further disadvantage is the fact that any misalignment of the shaft may cause the shaft to contact the cover and damage it.

It is therefore necessary to define a support assembly offering an improved design solution that can solve the abovementioned drawbacks of known support assemblies.

With a view to substantially solving the above technical problems, one aim of the present disclosure is to define a support assembly and associated bearing unit secured to a machine frame that provides a novel anchoring system to secure the cover to the support assembly and an improved seal to protect the bearing unit from contaminants and/or washing.

Specifically, a support assembly according to this disclosure includes a cover that creates a dynamic seal directly with the bearing unit, protecting the latter from contaminants and from washing water.

Moreover, a support assembly according to this disclosure includes a cover firmly anchored to the bearing unit.

Purely by way of non-limiting example and with reference to the above figures, a support assembly 10 is illustrated. In some embodiments, support assembly 10 may be applied to a movable, rotating, or sliding shaft.

In some embodiments, a support assembly 10 may include a bearing unit 30 adapted to receive a shaft 50 that supports bearing unit 30, and a casing 20. Casing 20 may include a through seat 40 that receives bearing unit 30. In some embodiments, bearing unit 30 may be a roller bearing. In some embodiments, shaft 50 may be a rotating shaft. In some embodiments, support assembly 10 may be mounted on machinery (not illustrated) for the food and beverage industry.

In some embodiments, casing 20 may have a generally annular shape and may receive bearing unit 30 inside it, and in particular receive bearing unit 30 in through seat 40. In some embodiments, through seat 40 may have an axis of symmetry X that coincides with an axis of symmetry of casing 20 and with an axis of symmetry of bearing unit 30.

Throughout the present description and in the claims, terms and expressions indicating positions and directions such as “radial”, “axial” and “transverse”, are to be understood with reference to axis of symmetry X.

In some embodiments, bearing unit 30 may be provided with a radially outer ring 31, a radially inner ring 33 connected to shaft 50 by a securing means 55, a row of rolling bodies 32 interposed between radially outer ring 31 and radially inner ring 33, and one or more sealing devices, e.g., sealing devices 34, 35, for protecting the rolling bodies of row of rolling bodies 32 and associated raceways (not illustrated) of outer ring 31 and inner ring 33 of bearing unit 30 against external contaminants and water. In some embodiments, outer ring 31 may be stationary and inner ring 33 may be rotating about a central axis of rotation of bearing unit 30. In other embodiments, outer ring 31 may be rotating about a central axis of rotation of bearing unit 30 and inner ring 33 may be stationary. In some embodiments, rolling bodies 32 may be balls, rollers, needle rollers, or other known rolling bodies.

In some embodiments, a sealing device 35 may be positioned on a side of bearing unit 30 axially opposite securing means 55. Sealing device 35 may include a first shield 35a having an elastomeric coating and a second shield 35b also having an elastomeric coating. In some embodiments, both first shield 35a and second shield 35b may include a plurality of pairs of annular sealing lips 36, where each lip of each pair of annular sealing lips 36 radially and axially overlaps the other lip of a respective pair of lips 36. Each lip of each pair of annular sealing lips 36 may also be radially and axially separate such that each lip may be free to move independently of the other lip of the respective pair of lips 36 and without any contact with the other lip in of the respective pair of lips 36. Conversely, on a same axial side of bearing unit 30 as securing means 55, a sealing device 34 may include only a first shield 34a having an elastomeric coating and including a plurality of pairs of sealing lips 36.

In some embodiments, support assembly 10 may further include a cover 60 mounted on bearing unit 30 on the same axial side as securing means 55. Cover 60 is adapted to seal bearing unit 30 in a fluid-tight manner to prevent contaminants and water from an external environment from entering into an interior of bearing unit 30. Due to the presence of cover 60, a sealing device on the same axial side, e.g., sealing device 34, may include only one shield, e.g., first shield 34a, and still provide an adequate seal that prevents contaminants and water from the external environment from entering an interior of bearing unit 30. However, while not illustrated, it will be appreciated by one or ordinary skill in the art that sealing device 34 may alternatively also include a second shield similar to second shield 35b of sealing device 35 without departing from the scope of this disclosure.

In some embodiments, cover 60 may include a bottom wall 61 that may include a circular opening 62 through which shaft 50 may pass. Cover 60 may further include a substantially cylindrical side wall 63 integrally connected to bottom wall 61. An end of side wall 63 distal to bottom wall 61 may include an engaging portion 64 that engages radially outer ring 31 of bearing unit 30. In some embodiments, cover 60 may be substantially bowl shaped.

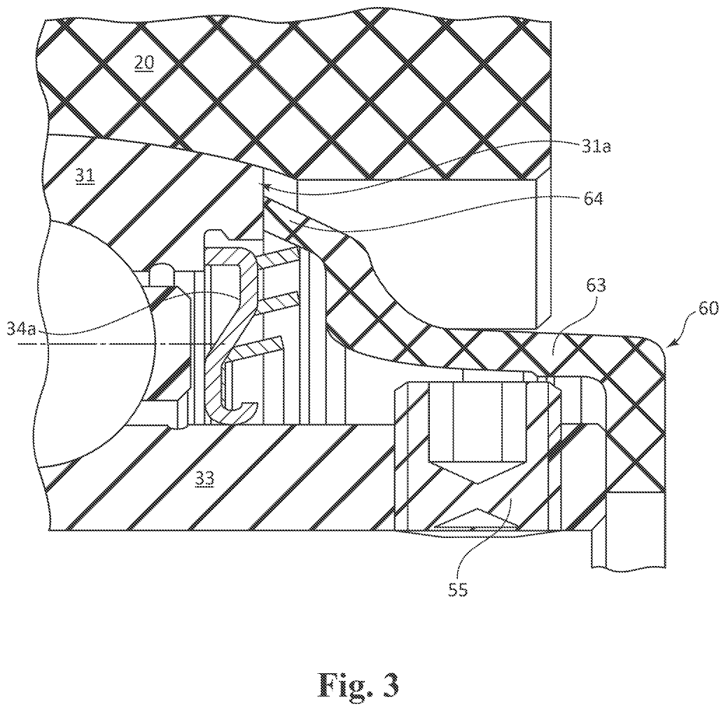

As illustrated in FIG. 3, engaging portion 64 may engage an axially outward facing end of radially outer ring 31. In some embodiments, engaging portion 64 may engage with an annular surface 31a of radially outer ring 31 and provide a dynamic seal therewith. In some embodiments, the dynamic seal may be of a sliding contact type. Alternatively, in other embodiments, the dynamic seal may be a labyrinth seal of a non-contacting type. Advantageously, the dynamic seal between cover 60 and radially outer ring 31, whether with sliding contact or a labyrinth seal, makes it possible to centrifuge any washing water and/or contaminants and thus create a more efficient seal as compared to static seals formed between the cover and the casing.

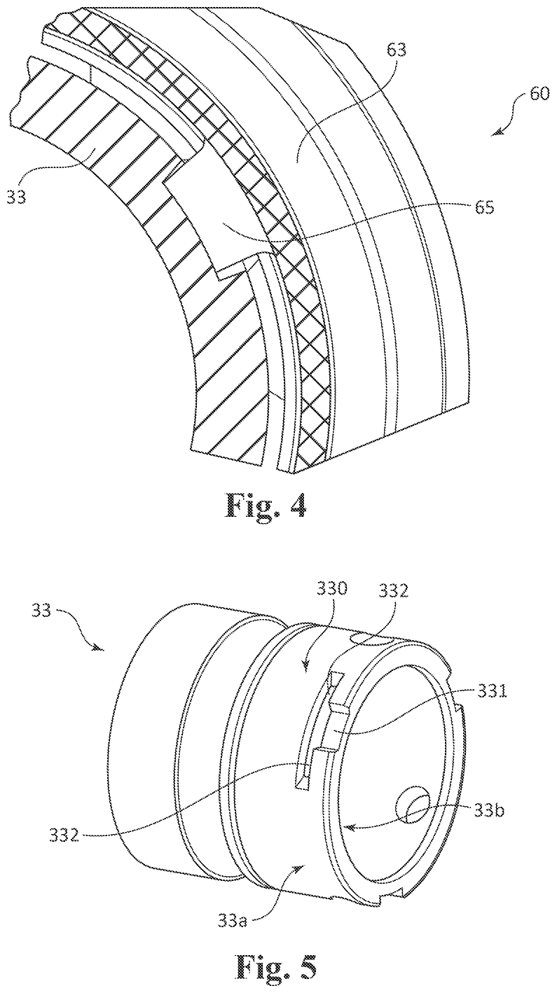

As seen in FIGS. 4 and 5, side wall 63 of cover 60 may include a plurality of teeth 65 projecting radially inwards from cover 60 and spaced apart circumferentially, each extending over a circumferential segment of side wall 63.

In some embodiments, a radially outer lateral surface 33a of radially inner ring 33 may include a plurality of annular seats 330 that each receive a corresponding tooth 65 of plurality of teeth 65. In some embodiments, each annular seat 330 may include an inlet groove 331 spaced axially with respect to a front edge 33b of radially inner ring 33 and interrupting radially a portion of front edge 33b of radially inner ring 33. Each annular seat 330 may further include a pair of anchoring grooves 332 arranged on a side opposite inlet groove 331 that engage with teeth 65 during use, anchoring cover 60 to bearing unit 30.

In some embodiments, plurality of teeth 65 and plurality of annular seats 330 are three in number and each is evenly spaced circumferentially about cover 60 and inner ring 33, respectively. In some embodiments, and each tooth 65 may be spaced 120° from one another, and each annular seat 330 may also be spaced 120° from one another.

During assembly, cover 60 may first be brought together with bearing unit 30 axially such that teeth 65 engage with corresponding inlet grooves 331 of annular seat 330. Next, the cover 60 may be rotated clockwise or counter-clockwise such that teeth 65 enter anchoring grooves 332, creating a stable “bayonet” coupling.

By coupling cover 60 to radially inner ring 33 and radially outer ring 31 of bearing unit and not coupling it to casing 20, cover 60 may advantageously have reduced radial dimensions comparably to known covers that couple to the casing rather than the inner ring of a bearing unit, since bearing unit 30 is contained within casing 20. Furthermore, the axial dimensions of cover 60 may also advantageously be reduced because cover 60 is an open cover that lacks an axial closure base.

In addition, the present disclosure makes it possible to dispense with a component, namely a second shield 34b of sealing device 34, advantageously reducing cost of production and complexity of the support assembly without sacrificing quality of the seal to protect bearing unit 30 from external contaminants and water.

In some embodiments, cover 60 may be made of plastic, such as but not limited to, thermoplastic polyurethane (TPU).

In some embodiments, a radial thickness of engaging portion 64 may range between 1.5 mm and 3 mm, inclusive, in order to maintain a sufficient rigidity of cover 60. The rigidity obtained by this range of radial thickness advantageously allows for the use of a material with a relatively low hardness, for example on the order of 55 Shore A, in the formation of engaging portion 64 and cover 60 as a whole. Furthermore, in some embodiments, a hardness of the elastomeric coating of the shields 35a, 35b, and 34a may be equal to 75 Shore A.

Thus, by forming engaging portion 64 with a material of a relatively low hardness, any sliding contact between engaging portion 64 and annular surface 31a of outer ring 31 is softer, i.e., less susceptible to wear.

In some embodiments, cover 60 may be produced with a higher hardness, in which case engaging portion 64 may still be made with a material having a relatively low hardness on the order of 55 Shore A. In such embodiments, engaging portion 64 may be made of polytetrafluoroethylene (PTFE).

In light of the above, various designs and sizes of cover 60 are possible: For example, by way of non-limiting examples, a cover 60 may be made as a single piece, having a thickness of 2 mm throughout, including a radial thickness of 2 mm of engaging portion 64 and a hardness of Shore A. This solution is suitable for creating a dynamic seal with sliding contact with radially outer ring 31. In another embodiment, a cover 60 may be made as a single piece, having a thickness of 2 mm throughout, including a radial thickness of 2 mm of engaging portion 64, and a hardness of 60 Shore A. This solution is suitable for creating a labyrinth dynamic seal with radially outer ring 31. In yet another embodiment, engaging portion 64 may be a separate part that is co-molded on cover 60. Cover 60 and engaging portion 64 have a thickness of 2 mm, but cover 60 has a hardness of 60 Shore A, whereas engaging portion 64 has a hardness of 55 Shore A. This solution is suitable for creating a dynamic seal with sliding contact with the radially outer ring 31.

The improved solution according to the present disclosure is thus characterized in that it defines a seal directly between the cover and the bearing unit at both the radially outer ring and the radially inner ring. This solution defines a new form of cover and a new form of radially inner ring for anchoring these two components together by way of a plurality of teeth and a plurality of annular seats.

Advantageously, the design of a support assembly 10 according to this disclosure, contact with the casing can be avoided even with a misalignment of a shaft 50 and a casing 20. In some embodiments, a misalignment may be as larger as 3° before contact between shaft 50 and casing is realized. In addition to the embodiments of the disclosure described herein, it is to be understood that there are numerous other variants. It is also to be understood that said embodiments are solely exemplary and do not limit the scope of the disclosure, its applications, or its possible configurations. On the contrary, although the above description enables those skilled in the art to apply the present disclosure in at least one exemplary embodiment, it is to be understood that numerous variations of the described components are possible, without thereby departing from the scope of the disclosure as defined in the appended claims, interpreted literally and/or according to their legal equivalents.

It should be noted that the use of particular terminology when describing certain features or embodiments of the disclosure should not be taken to imply that the terminology is being re-defined herein to be restricted to include any specific characteristics of the features or embodiments of the disclosure with which that terminology is associated. Terms and phrases used in this disclosure, and variations thereof, especially in the appended claims, unless otherwise expressly stated, should be construed as open-ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least”; the term “such as” should be interpreted as “such as, without limitation”; the term “includes” should be interpreted as “includes but is not limited to”; the term “example” is used to provide exemplary instances of the item in discussion, not an exhaustive or limiting list thereof, and should be interpreted as “example, but without limitation”; adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

We claim:

1. A support assembly for a shaft, comprising:
a bearing unit configured to receive the shaft, the bearing unit comprising:
a radially inner ring; and
a radially outer ring comprising an axially external annular surface; and
a cover comprising:
a bottom wall;
a side wall integrally connected to the bottom wall; and
a engaging portion extending from a distal end of the side wall;
wherein the cover is anchored to the radially inner ring, and
wherein between the axially external annular surface of the outer ring and the engaging portion of the cover a dynamic seal is formed.

2. The support assembly of claim 1, wherein,
the cover further comprises a plurality of teeth formed on a radially inner surface of the side wall; and
the radially inner ring comprises a plurality of annular seats formed on a radially outer lateral surface of the inner ring and configured to receive the plurality of teeth of the cover.

3. The support assembly of claim 2, wherein each annular seat of the plurality of annular seats comprises:
an inlet spaced axially from and radially interrupting a front edge of the radially inner ring; and
a pair of circumferential anchoring grooves formed in the outer later surface of the inner ring and axially internal relative to the inlet,
wherein the inlet and the pair of anchoring grooves form a continuous passageway configured to receive at tooth of the plurality of teeth of the cover.

4. The support assembly of claim 3, wherein each tooth is configured to be introduced into one anchoring groove of the pair of anchoring grooves of each annular seat upon rotation of the cover.

5. The support assembly of claim 1, wherein the cover further comprises a circular opening in the bottom wall configured to receive the shaft of the support assembly.

6. The support assembly of claim 1, wherein the dynamic seal is a sliding contact seal.

7. The support assembly of claim 1, wherein the dynamic seal is a labyrinth seal.

8. The support assembly of claim 1, wherein the bearing unit further comprises:
a first annular sealing device on a side of the bearing unit axially opposite the cover, the first sealing device comprises:
a first shield comprising a plurality of pairs of sealing lips; and
a second shield comprising a plurality of pairs of sealing lips; and
a second annular sealing device on a same axial side of the bearing as the cover, the second sealing device comprising:
a first shield comprising a plurality of sealing lips extending toward the cover.

9. The support assembly of claim 1, wherein a radial thickness of the engaging portion comprises between 1.5 mm and 3 mm.

10. The support assembly of claim 1, wherein the cover is made of thermoplastic polyurethane.

11. The support assembly of claim 9, wherein the engaging portion of the cover has a hardness of between 55 Shore A and 60 Shore A.

12. The support assembly of claim 1, wherein the engaging portion is co-molded on the cover and comprises polytetrafluoroethylene comprising a hardness of 55 Shore A.

13. A bearing unit comprising:
a radially outer ring; and
a radially inner ring comprising a plurality of annular seats formed on a radially outer lateral surface thereof; and
wherein the plurality of annular seats are configured to receive a plurality of teeth of a cover for the bearing unit.

14. The bearing unit of claim 13, wherein each annular seat of the plurality of annular seats comprises:
an inlet spaced axially from and radially interrupting a front edge of the radially inner ring; and
a pair of circumferential anchoring grooves formed in the outer later surface of the inner ring and axially internal relative to the inlet, wherein the pair of anchoring grooves is configured to anchor the cover to the bearing unit.

15. The bearing unit of claim 13, further comprising:
a first annular sealing device configured to be housed on a side of the bearing unit axially opposite the cover, the first sealing device comprises:
a first shield comprising a plurality of pairs of sealing lips; and
a second shield comprising a plurality of pairs of sealing lips; and
a second annular sealing device configured to be housed on a same axial side of the bearing as the cover, the second sealing device comprising:
a first shield comprising a plurality of sealing lips extending toward the cover.

16. A cover, comprising:
a bottom wall comprising an opening;
a side wall integrally connected to the bottom wall;
a engaging portion extending from a distal end of the side wall and configured to form a dynamic seal with a radially outer ring of a bearing unit; and
a plurality of teeth configured to secure the cover to a radially inner ring of the bearing unit.

17. The cover of claim 16, wherein a hardness of the engaging portion is between 55 Shore A and 60 Shore A.

18. The cover of claim 17, wherein a radial thickness of the engaging portion comprises between 1.5 mm and 3.0 mm.

19. The cover of claim 16, wherein the cover is made of thermoplastic polyurethane.

20. The cover of claim 16, wherein the engaging portion is co-moulded onto the side wall of the cover and comprises a hardness of 55 Shore A.
